(19) United States
(12) Patent Application Publication
(10) Pub. No.: US 2005/0007026 A1
(43) Pub. Date: Jan. 13, 2005

(54) Method and apparatus for generating uniform images of active matrix OLED display devices

(76) Inventors: Shin-Tai Lo, Miaoli City (TW); Yung-Chou Chan, Changhua (TW)

Correspondence Address: BIRCH STEWART KOLASCH & BIRCH, PO BOX 747, FALLS CHURCH, VA, 22040-0747, US

(21) Appl. No.: 10/612,963

(22) Filed: Jul. 7, 2003

(51) Int. Cl. G09G 3/10

(52) U.S. Cl. 315/169.3

(57) ABSTRACT

A method and apparatus aims at generating uniform images of an active matrix OLED display device which consists of a plurality of pixel devices. Each of the pixel devices includes a driver unit to drive an OLED to display. The cathode of the OLED connects to a positive power supply which provides a voltage to increase the electric potential of the OLED and reduce the voltage difference between the source electrode and the drain electrode (Vsd) of the driver unit during operation and keep the voltage difference between the source electrode and the gate electrode (Vsg) unchanged so that output current fluctuations of the driver unit decreases while the driver unit is ON when the threshold voltages are different due to characteristic variations of the driver unit.

### FIELD OF THE INVENTION

The present invention relates to a method and apparatus for generating uniform images of active matrix organic light emitting diode (OLED) display devices and particularly to a method and apparatus that controls output current of driving TFTs without fluctuating excessively by reducing the Vsd (voltage difference between the source and the drain electrodes) and maintaining the Vsg (voltage difference between the source and the gate electrodes) of the driving TFTs.

### BACKGROUND OF THE INVENTION

The known thin film transistor liquid crystal display (TFT LCD) technologies at present can be classified in amorphous silicon TFT (á-Si TFT) and Poly-Si TFT. The generally called TFT-LCD is á-Si TF which is technically well developed and is the main stream of LCD products. The main difference between the low temperature Poly-Si TFT (LTPS TFT) and á-Si TFT is that the LTPS transistor requires laser annealing operation during the manufacturing process to transform the amorphous silicon thin film to poly silicon thin film so that the silicon structure of the LTPS is aligned more orderly than á-Si TFT. It can increase electron transfer speed up to 200 cm²/V-sec. The LTPS technology enables elements to be made in a smaller size. The area of the whole TFT element can be shrunk 50% or more. The aperture ratio may also be improved. Comparing with á-Si TFT-LCD of the same dimension, LTPS TFT has a higher resolution and lower power consumption. Furthermore, LTPS TFT has other advantages such as power saving, greater light brightness, finer picture, thin and light, and fewer connection points (less than 200 connection points, that improves yields, while á-Si TFT has more than 3842 connection points).

However, in the manufacturing process of LTPS the thin film transistor has to go through a laser annealing operation that often results in changes of the threshold voltage and mobility of the TFT. Hence the characteristics of every TFT element are different. When a driver system uses analog modulation method to present gray scale, the different characteristics of the TFT resulted from the laser annealing operation cause OLEDs of different pixels to generate different currents even if same voltage signals are programmed, and different light brightness are generated. This phenomenon causes the OLED panel to display erroneous gray scale images and image uniformity suffers severely.

U.S. Pat. No. 5,684,365, entitled “TFT-el display panel using organic electroluminescent media” discloses a technique which has a pixel circuit consisting of two TFTs and a capacitor. When the pixel device scans image data, the switch unit is ON and image data enter the switch unit through the data line. After scanning by the scan line, the data are stored in the storage unit (i.e. charge the storage unit after the switch unit is ON). The voltage difference of the storage unit provides Vsg (voltage difference between the source and the gate electrodes) of the driver unit to enable the driver unit to output current to the OLED element. The OLED element generates light with a brightness in direct proportion to the passing current. However, if the element properties of the driver unit of the pixel device change due to manufacturing process, light generated by the OLED element is not even, and image uniformity suffers.

To remedy the aforesaid problem and improve image uniformity of the display device, digitized driving structures have been developed. They employ time ratio modulation to display gray scale. The operation principle is to control display and non-display of OLED through controlling ON and OFF of TFT, and through the time ratio of OLED display time in the frame time to determine the image gray scale.

However, the digitized driving OLED still has critical technical issues pending to be overcome, notably:
1. When the TFTs of the display panel are in the ON condition, output current non-uniformity must be sufficiently small.
2. When the TFTs of the display panel are in the OFF condition, all the TFTs must have no output current.

### SUMMARY OF THE INVENTION

Therefore the primary object of the invention is to resolve the aforesaid disadvantages. The invention provides a method and apparatus for generating uniform images of active matrix OLED display devices in which the cathode of every OLED connects to a positive power supply to increase the electric potential of the OLED and reduce Vsd (voltage difference between the source and the drain electrodes) and keep Vsg (voltage difference between the source and the gate electrodes) unchanged so that when each TFT is in the ON condition output current fluctuation is reduced.

In order to achieve the foregoing object the display device according to the method and apparatus of the invention includes a plurality of pixel devices. Each pixel device has a driver unit to drive the OLED to display. The cathode of the OLED connects to a positive power supply which provides a voltage to increase the electric potential of the OLED and consequently reduce the Vsd (voltage difference between the source and the drain electrodes) during the driver unit is operating while the Vsg (voltage difference between the source and the gate electrodes) remains unchanged. Thus when the threshold voltage of each driver unit is different due to characteristic variations and the driver unit is in the ON condition, output current fluctuation of the driver unit may become smaller.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic circuit diagram of the invention.

FIG. 2 is a schematic chart of the current-voltage relationship of the driver unit.

FIG. 3 is another schematic chart of the current-voltage relationship of the driver unit.

### DESCRIPTION OF THE PREFERRED EMBODIMENT

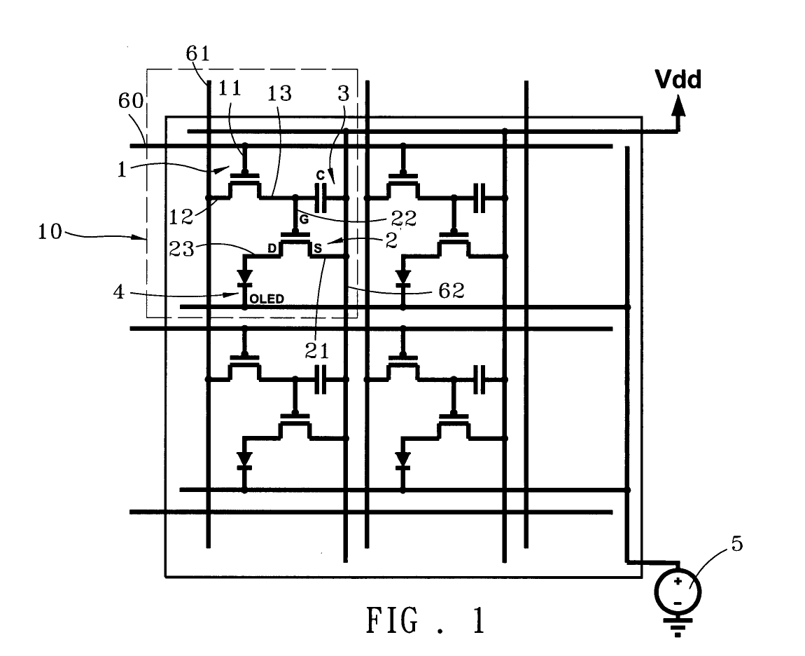

Refer to FIG. 1 for the circuit diagram of the invention. According to the method and apparatus of the invention, the active matrix OLED display device includes a plurality of pixel devices 10. Each of the pixel devices 10 has a driver unit 2 to drive an OLED 4 to display. The cathode of the OLED 4 connects to a positive power supply 5 which provides a voltage to increase the electric potential of the cathode of the OLED 4 and consequently reduces the Vsd (voltage difference between the source and the drain electrodes) of the driver unit 2 during operation while the Vsg (voltage difference between the source and the gate electrodes) remains unchanged. Thus when the threshold voltage of each driver unit 2 is different due to characteristic variations, output current non-uniformity among each driver unit 2 in the ON condition may become smaller.

Adopted the method set forth above, the pixel device 10 of the invention consists of a switch unit 1, a driver unit 2, a storage unit 3 and an OLED 4.

The switch unit 1 is a thin film transistor (TFT) which has two inputs 11 and 12 connecting respectively to a scan line 60 and a data line 61.

The driver unit 2 is a TFT which has one input 21 connecting to a supply line 62 and another input 22 connecting to the output 13 of the switch unit 1.

The storage unit 3 includes a capacitor which has one end connecting to the supply line 62 and the other end connecting to the output 13 of the switch unit 1.

The OLED 4 has an anode connecting to the output 23 of the driver unit 2 and a cathode connecting to a positive power supply 5.

The positive power supply 5 provides a voltage to increase the electric potential of the cathode and the anode of the OLED 4 and consequently boost the electric potential at the output 23 of the driver unit 2. As a result, the Vsd (voltage difference between the source and the drain electrodes) is reduced during the driver unit 2 is operating while the Vsg (voltage difference between the source and the gate electrodes) remains unchanged. Thus when the threshold voltage of each driver unit 2 is different due to characteristic variations, output current non-uniformity among each driver unit 2 in the ON condition may become smaller.

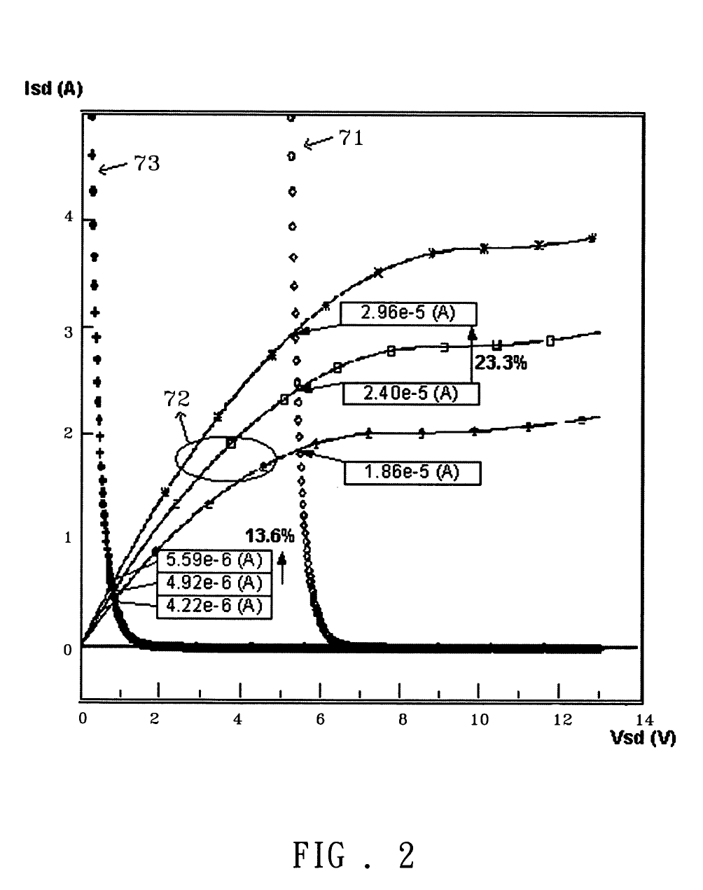

Refer to FIG. 2 for the current-voltage relationship of the driver unit of the invention that indicates the result achieved by the invention. As shown in the drawing, when input voltage Vdd of the supply line 62 is 13V and input voltage signal of the data line 61 is 0V, in the conventional driving apparatus, the driver unit 2 has a conventional loading curve 71, and the Vsd operating point of the conventional driver unit is located on the cross point of the conventional loading curve 71 and a first characteristic curve 72 of the driver unit 2 (with the input voltage Vdd of the supply line being 13V and input voltage signal Vdata of the data line being 0V).

Assuming that TFT element has threshold voltage (Vth) variation of +/−1.5V caused by manufacturing processes, output current non-uniformity is 23.3% for the conventional driver unit as shown in the drawing when Vth has the variation of −1.5V.

In contrast, when the driving apparatus of the invention is used, and in the event that the voltage of the cathode potential of the OLED provided by the positive power supply is 5V, the driver unit 2 of the invention has a loading curve 73, thus the Vsd operating point of the driver unit 2 is located on the cross point of the loading curve 73 and a first characteristic curve 72 of the driver unit 2. Assuming that threshold voltage of the TFT element has threshold voltage (Vth) fluctuation of −1.5V caused by manufacturing processes, experiment results prove that output current fluctuation is merely 13.6% for the driver unit 2.

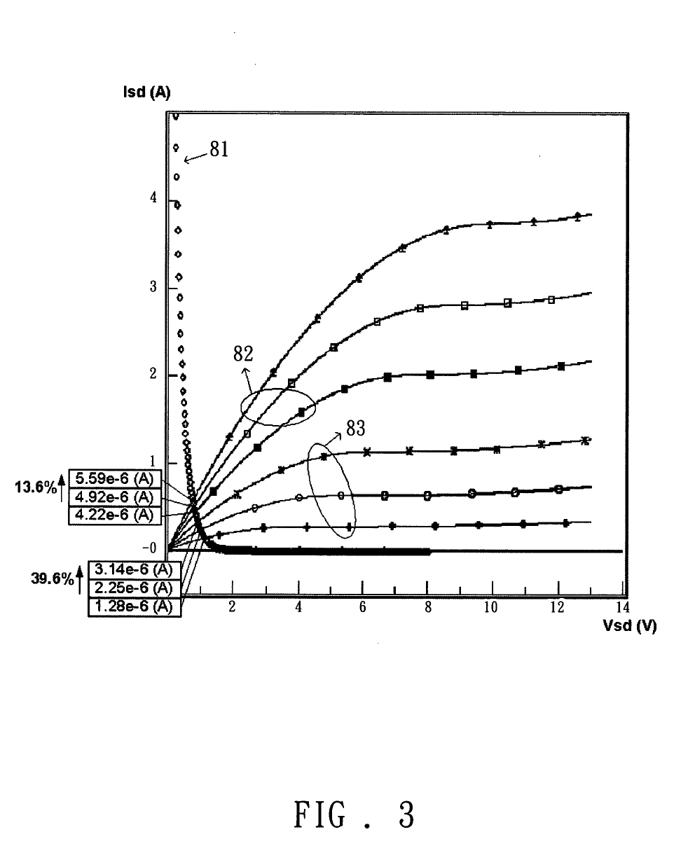

Refer to FIG. 3 for another current-voltage relationship of the driver unit of the invention. As shown in the drawing, when the driving apparatus of the invention is used, and in the event that the voltage Vdd of the supply line 62 is 13V, input voltage signal of the data line 61 is 0V and the voltage of the cathode potential of the OLED provided by the positive power supply is 5V, the driver unit 2 of the invention has a loading curve 81. Thus, the Vsd operating point of the driver unit 2 is located on the cross point of the loading curve 81 and a second characteristic curve 82 of the driver unit 2.

On the other hand, in the conventional driving apparatus with the voltage Vdd of the supply line 62 being at 8V and input voltage signal of the data line 61 being at 0V, the driver unit 2 of the conventional driving apparatus has the same loading curve 81 as the driver unit 2 of the invention. However, the voltage Vsg of the driver unit 2 becomes smaller and reaches 8V, the Vsd operating point of the conventional driver unit is located on the cross point of the loading curve 81 and a third characteristic curve 83 (Vsg=8V) of the conventional driver unit 2. In the event that TFT element has threshold voltage (Vth) variation of +/−1.5V caused by manufacturing processes, output current fluctuation is 39.6% for the conventional driver unit.

When the driver unit of the invention is used, as the voltage of the cathode potential of the OLED provided by the positive power supply is 5V, the voltage Vdd of the supply line 62 is 13V and input voltage signal Vdata of the data line 61 is 0V, the Vsd operating point of the driver unit 2 is located on the cross point of the loading curve 81 and the second characteristic curve 82 (Vsg=13V) of the driver unit 2. Thus when the TFT element has threshold voltage (Vth) variation of +/−1.5V caused by manufacturing processes, output current fluctuation is merely 13.6% for the driver unit 2.

In summary, in the conventional driving apparatus, when the voltage (Vdd) of the power supply decreases, while Vsd of the conventional driver unit may become smaller, Vsg also is smaller and results in greater impact on the output current of the conventional driver unit caused by characteristic variations. In contrast, the invention can maintain a constant Vsg while the Vsd of the driver unit 2 decreases. Thus, when the TFT is ON, output current is not greatly affected by TFT characteristic variations.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. An apparatus for generating uniform images of an active matrix organic light emitting diode (OLED) display device which consists of a plurality of pixel devices, each of the pixel devices comprising:
a switch unit having two input ends and an output end, the two input ends connecting respectively to a data line and a scan line;
a storage unit having one end connecting to a supply line and another end connecting to the output end of the switch unit;
a driver unit having two input ends and an output end, one input end connecting to the supply line and another input end connecting to the output end of the switch unit; and
an OLED having an anode and a cathode, the anode being connected to the output unit of the driver unit and the cathode being connected to a positive power supply;
wherein the positive power supply provides a voltage to increase the electric potential of the cathode and the anode of the OLED and the electric potential of the output end of the driver unit and reduce the voltage difference of the source electrode and the drain electrode (Vsd) of the driver unit during operation and keep the voltage difference of the source electrode and the gate electrode (Vsg) unchanged.

2. The apparatus of claim 1, wherein the switch unit is a thin film transistor.

3. The apparatus of claim 1, wherein the driver unit is a thin film transistor.

4. The apparatus of claim 1, wherein the storage unit includes a capacitor.

5. A method for generating uniform images of an active matrix organic light emitting diode (OLED) display device which consists of a plurality of pixel devices, each of the pixel devices comprising a driver unit to drive an OLED to display, the method comprising steps of:
connecting a cathode of the OLED to a positive power supply to provide a voltage to increase the electric potential of the OLED;
reducing the voltage difference of the source electrode and the drain electrode (Vsd) of the driver unit during operation; and
keeping the voltage difference of the source electrode and the gate electrode (Vsg) unchanged so that output current fluctuations of the driver unit decrease while the driver unit is ON when the threshold voltages are different due to characteristic variations of the driver unit.
